(19) United States
(12) Patent Application Publication
(10) Pub. No.: US 2003/0082019 A1
(43) Pub. Date: May 1, 2003

(54) Presser foot assembly

(76) Inventor: Richard Kuchta, Shickshinny, PA (US)

Correspondence Address: McCormick, Paulding & Huber, City Place II, 185 Asylum Street, Hartford, CT, 06103-3402, US

(21) Appl. No.: 10/001,529

(22) Filed: Oct. 25, 2001

(51) Int. Cl. B23B 41/00

(52) U.S. Cl. 408/97

(57) ABSTRACT

A presser foot assembly for use with a machine tool for engaging a work material during a cutting process. The presser foot assembly having a guide rod for supporting a presser foot wherein the presser foot engages a work material during a cutting process. A bias means urges the guide rod in an extended position towards the work material such that the presser foot engages the work material before the cutting tool and exerts pressure on the work material during a cutting process. Following completion of the cutting process the cutting tool is first removed from the work material followed by the presser foot being disengaged therefrom.

### CROSS REFERENCE TO RELATED APPLICATIONS

The present application is related to co-pending application, Ser. No. 09/916,003 filed on Jul. 26, 2001 and entitled “Multi-Spindle Drive and Belt Tensioning Assembly” by inventor, Richard Kuchta, (Attorney Docket No. G48-1313), said application being incorporated herein by reference.

### FIELD OF THE PRESENT INVENTION

The present invention is generally directed to a presser foot assembly for use with a machine tool for engaging a work material during a cutting procedure. More specifically, the present invention is directed to a presser foot assembly for use with a drilling machine wherein the presser foot assembly includes a presser foot for engaging a work material during a drilling procedure.

### BACKGROUND OF THE PRESENT INVENTION

Machine tools, especially cutting tools employed to cut fabric, leather, or other sheet-type material generally employ a “presser foot” to exert pressure onto the work material during a cutting process. Often a cutting tool such as a knife or a drill extends through the presser foot to engage the work material. To facilitate positioning of the work material relative to the cutting tool, the presser foot is usually moveable between a raised position, wherein the presser foot is positioned away from the work, and a lowered position, wherein the presser foot engages the work material. The presser foot is often accomplished via movable guide rods that extend between the machine tool and the presser foot. Often, the presser foot is pneumatically operated and the guide rods are air cylinders.

Many air cylinders used with pneumatic presser foot assemblies do not provide smooth and precise movement of the presser foot as may be required for use with some precision machine tools. Limitations in the precision of the motion of many air cylinders available for presser foot assemblies may result in the presser foot being positioned away from a cutting tool more than is desired. For instance, in some cutting procedures, such as a drilling operation, it may be advantageous to position the presser foot adjacent to or surrounding the drill bit with very close tolerances therebetween. Many air cylinders do not provide adequate precision to allow these close tolerance movements. Also, pneumatic presser foot assemblies require a pressurized gas source which can result in cumbersome and multiplicative plumbing and control schemes.

Based on the foregoing, it is the general object of the present invention to provide a presser foot assembly that overcomes the problems and drawbacks of the prior art.

### SUMMARY OF THE INVENTION

The present invention is directed in one aspect to a presser foot assembly for use with a machine tool. A machine tool employing a presser foot assembly includes a frame having a spindle rotatably mounted thereto. A cutting tool is coupled to an end of the spindle. A housing coupled to the spindle adjacent to the cutting tool supports the presser foot assembly. A presser foot support is attached to the housing. A movable guide rod slidably supported at a first end by the presser foot support is movable toward and away the work material. A biasing means urges the guide rod toward the work material such that a presser foot attached to a second end of the guide rod engages the work material during a cutting process. The presser foot support can include at least two vertically aligned bearings for supporting the guide rod.

The present invention presser foot assembly is described herein as used with a triple drill, which is a drill having three independently operable spindles each adapted with a foot presser assembly and each adapted to releasably retain a drill bit or cutting tool. However, while the present invention presser foot assembly is particularly suitable for use with the triple drill described and illustrated herein, it should be understood that the invention is not limited in this regard. The present invention presser foot assembly may be used with any machine tool wherein it is desirous to engage and exert pressure on a work material during a cutting procedure.

The presser foot assembly as used with the triple drill, includes a pair of movable guide rods for supporting a presser foot. The guide rods are biased toward the work material such that the presser foot engages and exerts pressure against the work material during a drilling process. The guide rods are positioned one on either side of the cutting tool and in close proximity thereto, such that the presser foot engages the work material in close proximity to the cutting tool. The guide rods supporting the presser foot are aligned one on either side of the center of the cutting tool and separated by angle of 180 degrees therebetween. The presser foot is attached to the lower ends of the guide rods and has an opening therein for the cutting tool to pass therethrough during the drilling process. A bushing disposed in the opening in the presser foot facilitates alignment of the cutting tool.

### BRIEF DESCRIPTION OF THE DRAWINGS

FIG. 1 is a partial cross-sectional, side elevational view of the triple drill embodying the present invention presser foot assembly;

FIG. 2 is an exploded view of the present invention presser foot assembly attached to a spindle of the triple drill;

FIG. 3 is a front side elevational view of the spindle of the triple drill embodying the present invention;

FIGS. 4A-4D are top, front, bottom and left side views, respectively of the drill bearing housing of the triple drill embodying the presser foot supports of the present invention presser foot assembly;

FIG. 4E is a cross-sectional view of the drill bearing housing of the triple drill embodying the presser foot supports of the present invention taken along line B-B of FIG. 4D;

FIG. 5 is an exploded elevational view of the guide rods and presser foot of the present invention;

FIG. 6 is top view of the presser foot of the present invention; and

FIG. 7 is an assembled elevational view of the guide rods and presser foot of the present invention.

### DETAILED DESCRIPTION OF THE PREFERRED EMBODIMENT OF THE PRESENT INVENTION

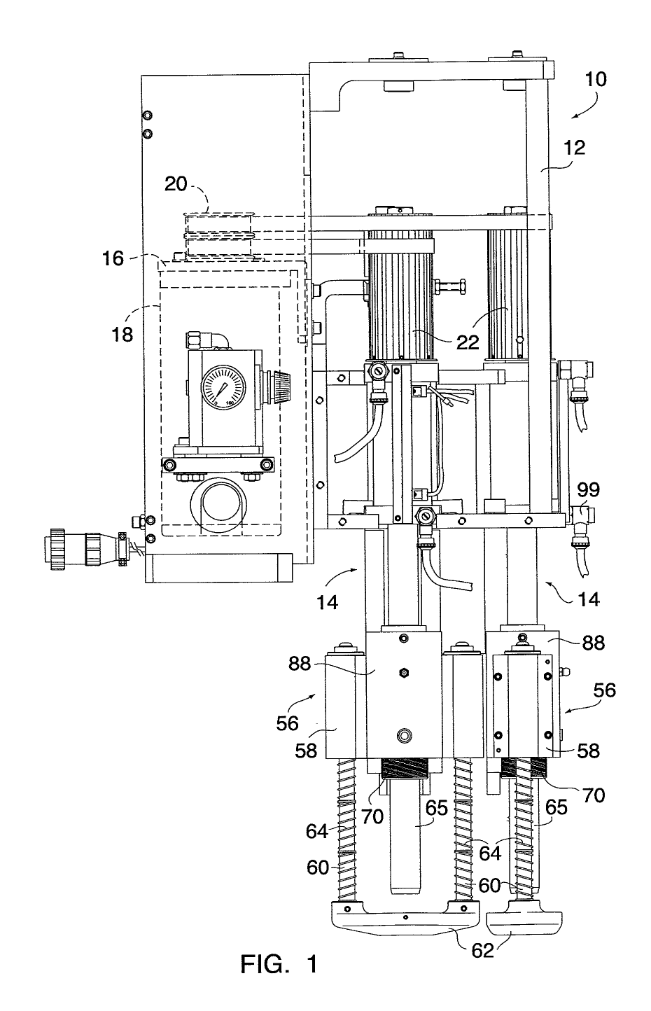

As shown in FIG. 1 a triple drill generally designated by reference number 10 includes frame 12, and spindle assemblies, generally 14. (In FIG. 1, a third spindle assembly can not be seen as it is positioned on triple drill 10 directly rearward of spindle assembly 14 shown in a front view). Referring again to FIG. 1, a motor bracket 16 is attached to frame 12 and has a motor 18 (shown in dotted lines) fastened thereto. Drive pulley 20 (also shown in dotted lines) is coupled for rotation to the motor 18. In addition, a driven pulley 22 is mounted for rotation to each of the spindle assemblies 14.

Spindle assembly 14 is mounted for rotation to frame 12 and has a drill bearing housing 88 mounted thereto. The present invention presser foot assembly, indicated generally at 56, includes presser foot supports 58 attached to drill bearing housing 88. Each presser foot support 58 having a guide rod 60 slidably extending therefrom. A presser foot 62 is attached to the lower ends of guide rods 60. Coil spring 64 is positioned over each guide rod 60 between presser foot 62 and presser foot support 58 biasing the guide rods 60 in an extended position toward the work material. Alternatively, any biasing means for urging the guide rod in an extended position such that the presser foot engages and exerts pressure against the work material during a cutting procedure is within the scope of the present invention.

During operation of triple drill 10, spindle assemblies 14, which are movable between a raised and a lowered position, move into engagement with the work material to be drilled. Presser foot 62 is attached to drill bearing housing 88, thus presser foot 62 is raised or lowered with tool 65. Presser foot 62 extends below tool 65, so that it engages the work to be drilled prior to tool 65 engaging the work. Depending on the thickness of the work, presser foot 62 via guide rods 60 sliding into or out of presser foot supports 58 moves up or down with respect thereto and is urged against the work by springs 64. Thus, lowering of drill bearing housing 88, first engages presser foot 62 with the work material followed by cutting tool 65 engaging the work material. Continued lowering of drill bearing housing 88 allows tool 65 to penetrate, or otherwise cut the work to be drilled and complete the drilling procedure while presser foot 62 exerts pressure on the work via springs 64. Following completion of the drilling procedure, drill bearing housing 88 is raised along with attached cutting tool 65 and presser foot 62 such that springed guide rods 60 fully extend from presser foot support 58 and presser foot 62 remains engaged with the work until cutting tool 65 is removed therefrom.

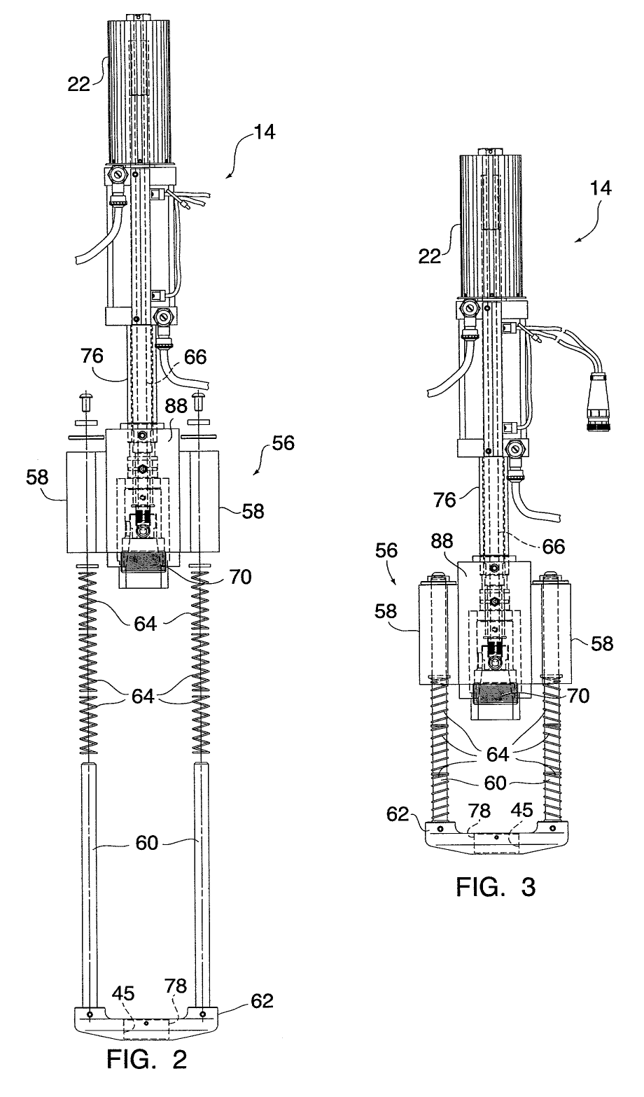

As shown in FIGS. 2 and 3, spindle assembly 14 includes a spindle shaft generally 66. A chuck 70 adapted to releasably retain a cutting tool is mounted on an end of spindle shaft 66. Drill bearing housing 88 is attached to an end of cylinder rod 76. Cylinder rod 76 is movable toward and away from the work material. Presser foot supports 58 are attached to drill bearing housing 88 such that presser foot assembly 56 moves toward or away from the work with drill bearing housing 88 via movement of cylinder rod 76. In one embodiment of the present invention, presser foot supports 58 are integral to drill bearing housing 88.

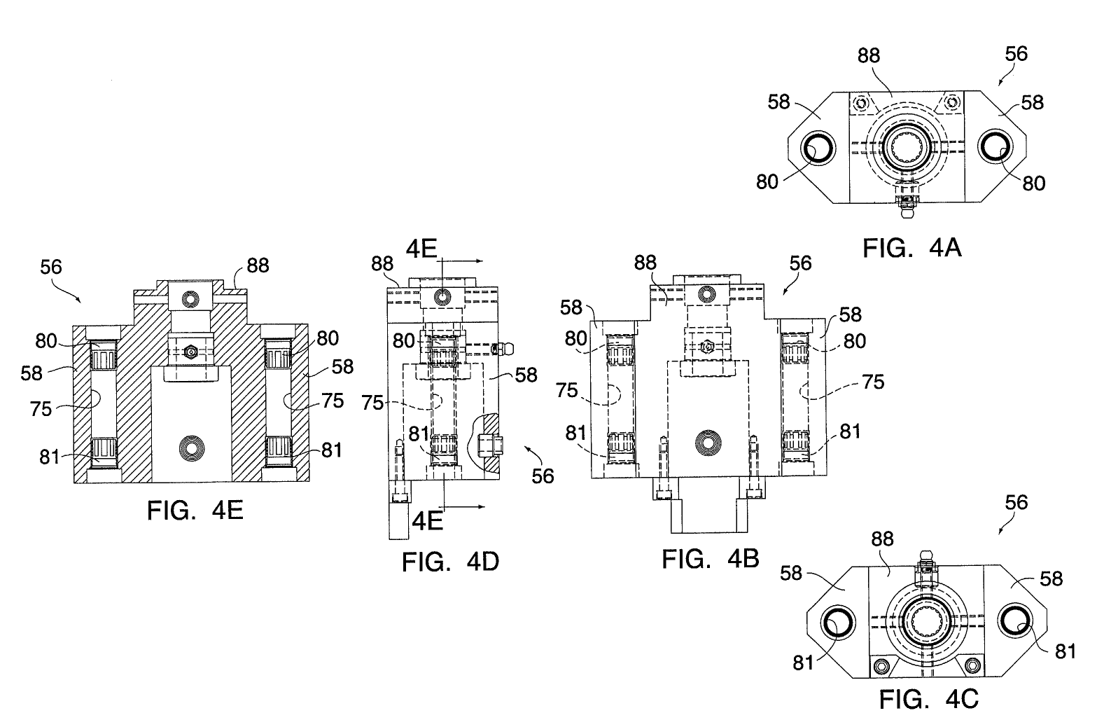

FIGS. 4A-4D show top, front, bottom and left side views of presser foot supports 58 attached to drill bearing housing 88 respectively. Upper bearings 80 and lower bearings 81 are spaced-apart one from the other and fixedly aligned in bores 75 of presser foot supports 58 for providing lateral support for guide rods 60. Bearings 80 and 81 can be linear bearings, ball bearings, self-lubricating bearings, or other suitable bearings or bushings for providing lateral support for movable guide rods 60.

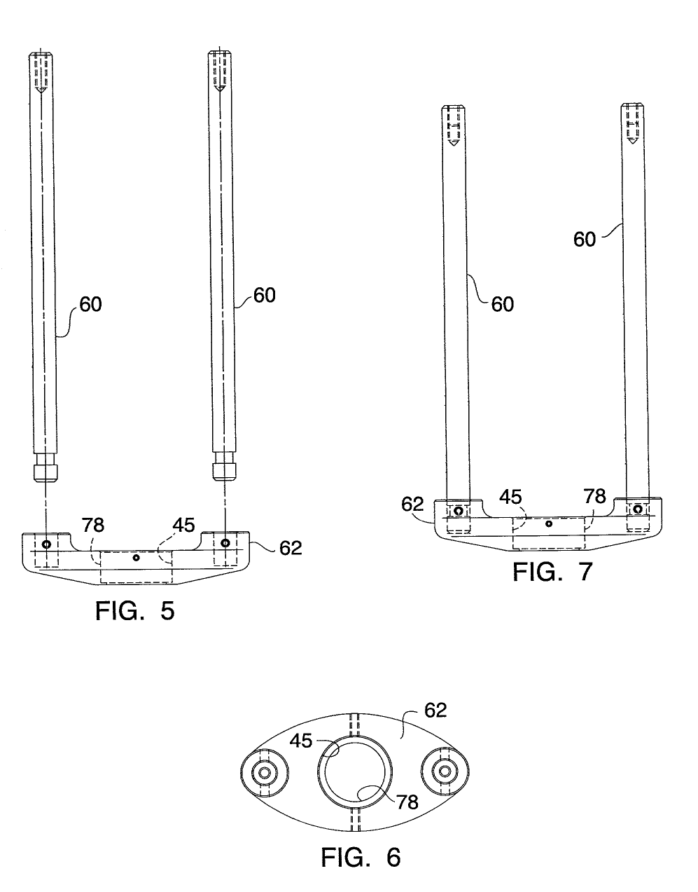

Referring to FIGS. 5-7, guide rods 60 attach at one end to presser foot 62. Opening 45 in presser foot 62 allows cutting tool 65 to pass therethrough for engaging the work material. Bushing 78 mounted in opening 45 facilitates precision alignment of cutting tool 65.

In the preferred embodiment of the present invention presser foot assembly 56 as used with the triple drill 10, the guide rods 60 are precision made hardened shafts of about 0.500 inches in diameter. Presser foot supports 58 are integral to drill bearing housing 88 and the centers of upper bearings 80 and lower bearings 81 are spaced apart about 3 inches such that the vertical axes of guide rods 60 are separated by a distance of about 3 inches therebetween.

While preferred embodiments have been shown and described, various modifications and substitutions may be made without departing from the spirit and scope of the invention. Accordingly, it is to be understood that the present invention has been described by way of example, and not by limitation.

What is claimed is:

1. A machine tool employing a presser foot assembly comprising:
a frame;
a spindle rotatably mounted to said frame;
a cutting tool coupled to an end of said spindle;
a housing coupled to said spindle adjacent to said cutting tool;
a presser foot support attached to said housing;
a movable guide rod slidably supported at a first end by said presser foot support such that said guide rod is movable toward and away said work material;
a biasing means urging said guide rod in an extended position toward said work material; and
a presser foot attached to a second end of said guide rod for engaging a work material during a cutting process.

2. A machine tool employing a presser foot assembly as defined in claim 1 wherein said biasing means is a coil spring disposed around said guide rod and between said presser foot support and said presser foot.

3. A machine tool employing a presser foot assembly as defined in claim 1 wherein said presser foot support further comprises bearing means for supporting said guide rod.

4. A machine tool employing a presser foot assembly as defined in claim 1 further comprising an opening in said presser foot for said cutting tool to pass therethrough during a cutting process.

5. A machine tool employing a presser foot assembly as defined in claim 4 further comprising a bushing in said opening in said presser foot for aligning said cutting tool.

6. A machine tool employing a presser foot assembly as defined in claim 3 wherein said bearing means comprises at least two vertically aligned bearings.

7. A machine tool employing a presser foot assembly as defined in claim 3 wherein said bearing means comprises linearbearings.

8. A machine tool employing a presser foot assembly as defined in claim 1 wherein said machine tool is a drilling machine.

9. A machine tool employing a presser foot assembly comprising:
a frame;
a spindle rotatably mounted to said frame;
a cutting tool coupled to an end of said spindle;
a housing coupled to said spindle adjacent to said cutting tool;
a presser foot support attached to said housing;
a movable guide rod slidably supported at a first end by said presser foot support such that said guide rod is movable toward and away said work material;
a biasing means urging said guide rod in an extended position toward said work material;
a presser foot attached to a second end of said guide rod for engaging a work material during a cutting process; and
an opening in said presser foot for said cutting tool to pass therethrough during a cutting process.

10. A machine tool employing a presser foot assembly as defined in claim 9 wherein said guide rod comprises a pair of guide rods disposed on opposite sides of said cutting tool and aligned one with the other.

11. A machine tool employing a presser foot assembly as defined in claim 10 wherein said biasing means further comprising a coil spring disposed around each said guide rod and between said presser foot support and said presser foot such that said guide rod is urged in an extended position towards said work material.

12. A machine tool employing a presser foot assembly as defined in claim 10 wherein said pair of guide rods is positioned such that the angular separation therebetween is about 180 degrees.

13. A machine tool employing a presser foot assembly as defined in claim 9 wherein said presser foot support further comprises bearing means for supporting said guide rods.

14. A machine tool employing a presser foot assembly as defined in claim 13 wherein said bearing means further comprises an upper bearing and a lower bearing for supporting each said guide rod respectively.

15. A machine tool employing a presser foot assembly as defined in claim 13 wherein said bearings means comprise linear bearings or bushings

16. A machine tool employing a presser foot assembly as defined in claim 14 wherein said bearings are bushings.

17. A machine tool employing a presser foot assembly as defined in claim 9 wherein said opening in said presser foot further comprises a bushing for aligning said cutting tool.
